(19) United States
(12) Patent Application Publication
(10) Pub. No.: US 2005/0131592 A1
(43) Pub. Date: Jun. 16, 2005

(54) In-flight control system stability margin assessment

(75) Inventor: Richard Y. Chiang, Torrance, CA (US)

Correspondence Address: SHIMOKAJI I FRITZ LLP, Suite 480, 1301 Dove Street, Newport Beach, CA, 92660, US

(73) Assignee: The Boeing Company, Chicago, IL (US)

(21) Appl. No.: 10/737,588

(22) Filed: Dec. 15, 2003

(51) Int. Cl. G06F 7/00

(52) U.S. Cl. 701/13

(57) ABSTRACT

A method for in-flight stability margin assessment includes steps of: exciting a control system with a wide band spectrum excitation signal to produce in-flight data; storing the in-flight data in an on-board computer during operation of a spacecraft mission; downloading the in-flight data via telemetry during operation of the spacecraft mission; estimating a system sensitivity function by taking the ratio of an output power spectrum to an input power spectrum; and determining stability margins of the attitude control system from the system sensitivity function by determining a gain margin GM and a phase margin PM from the formulas:

$$\begin{matrix}\frac{1}{1 - {a}_{min}} < GM < \frac{1}{1 + {a}_{min}} \\ PM > \pm {sin}^{- 1} ( \frac{{a}_{min}}{2} )\end{matrix}$$

where “aₘᵢₙ” is the reciprocal of the peak of the system sensitivity function. The method optionally includes redesigning and providing a new control law to the control system if deemed necessary.

### BACKGROUND OF THE INVENTION

The present invention generally relates to attitude control systems and, more particularly, to a method of assessing control system stability margins.

A current approach to assessing control system stability margins is to provide a dynamic model of the control system as it applies, for example, to a spacecraft, or other vehicle whose physical motion, or attitude, is to be controlled and assume that dynamic model can vary, say, +/−25%, then check the stability margins accordingly in simulation—such as a computer simulation. While being comforting by providing some information where there is a complete lack of data for prediction of stability margins, this approach lacks a rigorous theoretical underpinning and, consequently, can lead to one or another of the following in-flight situations: either an overly conservative prediction of stability margins or a poor prediction of insufficient stability margins. In either case, the design cost and man power to develop the control system have been unnecessarily wasted, the attitude control system is bound to be sensitive to physical uncertainty, and control system stability margin and performance will most likely be poor.

In general, stability margins of spacecraft attitude control systems have not been assessed directly in flight due to the possibility of pushing the spacecraft into its instability regions with the attendant risk of driving the spacecraft into instability and not being able to recover control. Actual missions of prior art spacecraft have experienced in-flight “surprises” or anomalies from time to time in terms of lacking control system stability. When such an incident occurs, it can be a very disappointing and costly situation. When the design and analysis work fail to predict control system stability due to lack of in-flight spacecraft dynamics knowledge, entry of the spacecraft into service is typically delayed and additional engineering resources are often spent solving the problem.

As can be seen, there is a need for in-flight stability margin assessment that can prevent the kind of anomaly described above. There is also a need for a stability test that identifies the critical stability margins of a closed-loop attitude control system using in-flight data without driving the attitude control system into its instability regions. Moreover, there is a need for verifying the spacecraft stability margins in-flight and obtaining a realistic assessment of control system stability at any particular phase of a mission.

### SUMMARY OF THE INVENTION

In one aspect of the present invention, a method for stability margin assessment includes determining a stability margin from in-flight data.

In another aspect of the present invention, a for in-flight stability margin assessment includes steps of: determining a stability gain margin from in-flight data; and determining a stability phase margin from the in-flight data.

In still another aspect of the present invention, a method for attitude control system stability margin assessment includes steps of: exciting a control system with a wide band spectrum excitation signal to produce input and output data; using the input and output data to estimate a system sensitivity function of the control system; and determining a stability margin of the control system from the system sensitivity function.

In yet another aspect of the present invention, a method for spacecraft attitude control system design includes steps of: exciting a control system with a white noise excitation signal to produce input and output data; storing the input and output data in an on-board computer during operation of a spacecraft mission; downloading the input and output data via telemetry during operation of the spacecraft mission; taking the discrete Fourier transform of the input autocorrelation function of the input data to create an input power spectrum of the input data; taking the discrete Fourier transform of the output autocorrelation function of the output data to create an output power spectrum of the output data; estimating a system sensitivity function by taking the ratio of the output power spectrum to the input power spectrum; determining a first stability margin of the attitude control system from the system sensitivity function by determining a gain margin GM from the formula:

$$\frac{1}{1 - {a}_{min}} < GM < \frac{1}{1 + {a}_{min}}$$

where “aₘᵢₙ” is the reciprocal of the peak of the system sensitivity function; and determining a second stability margin of the attitude control system from the system sensitivity function by determining a phase margin PM from the formula:

$$PM > \pm {sin}^{- 1} ( \frac{{a}_{min}}{2} )$$

where “aₘᵢₙ” is the reciprocal of the peak of the system sensitivity function.

In a further aspect of the present invention, a system for in-flight stability margin assessment includes: a physical plant; a controller that feeds control signals to the physical plant and receives feedback signals from the physical plant; a signal generator that excites the physical plant with white noise to provide input and output data; and an analysis subsystem. The analysis subsystem uses the input and output data to estimate a system sensitivity function of an attitude control system that includes the physical plant and the controller; and the analysis subsystem determines a stability margin of the attitude control system from the system sensitivity function.

In a still further aspect of the present invention, a spacecraft includes an attitude control system. The attitude control system includes a physical plant; a controller that feeds control signals to the physical plant; and a comparator, wherein the comparator receives a reference signal, the comparator receives a feedback signal from the physical plant, and the comparator provides a comparison signal to the controller. The spacecraft further includes a signal generator that excites the physical plant with white noise to provide input and output data from the attitude control system. The attitude control system is connected via telemetry to an analysis subsystem. The analysis subsystem uses the input and output data to estimate a system sensitivity function of an attitude control system that includes the physical plant and the controller; and the analysis subsystem determines a stability margin of the attitude control system from the system sensitivity function.

These and other features, aspects and advantages of the present invention will become better understood with reference to the following drawings, description and claims.

### BRIEF DESCRIPTION OF THE DRAWINGS

FIG. 1 is a system block diagram showing a summary of an approach for in-flight stability margin assessment according to one embodiment of the present invention;

FIG. 2 is a block diagram showing processing of data according to one embodiment of the present invention;

FIG. 3 is a time domain and frequency domain graph of a band limited white noise excitation signal in accordance with one embodiment of the present invention;

FIG. 4A is block diagram for defining gain and phase control system stability margins according to an embodiment of the present invention;

FIG. 4B is a graph in the complex plane for determining the system sensitivity function in accordance with an embodiment of the present invention;

FIG. 5 is a graph in the complex plane showing an example of determining stability margins as a function of system sensitivity function peak in accordance with an embodiment of the present invention;

FIG. 6 is a block diagram for a system simulation using a commercially available system simulation program for in-flight stability margin assessment according to one embodiment of the present invention; and

FIG. 7 is a frequency domain graph of a system sensitivity function according to an analytical model compared to a sensitivity function obtained in accordance with in-flight stability margin assessment according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, one embodiment of the present invention provides a method for assessment of control system stability margins that can be used during the flight of aerospace vehicles and spacecraft such as satellites. Using a special closed-loop stability test, one embodiment solves in a robust fashion the problem that prior art systems are unable to directly assess stability margins of a spacecraft control system in flight due to the difficulty and possibility of pushing the spacecraft into its instability regions. One embodiment includes an innovative method that identifies the critical stability margins of a closed-loop attitude control system using in-flight data without driving the system even anywhere near its instability regions. As a result, one embodiment can be used to verify spacecraft stability margins in-flight and obtain a much more realistic assessment of system stability at any particular phase of a spacecraft's mission.

One embodiment includes algorithms, software implementing the algorithms, and hardware executing the software for a set of in-flight stability measurement tools and procedures to access spacecraft stability margins. In one embodiment, the procedures can be turned on by an on-board computer—on board a satellite, for example—through a series of ground commands, and the on-board computer will telemeter down the time signal for ground processing. In-flight stability margins may then be calculated using the algorithm and formulae that are part of the set of in-flight stability measurement tools and procedures.

One embodiment of the present invention provides an opportunity, not present in prior art systems, for robust re-design of an aerospace vehicle attitude control system using the inventive in-flight stability assessment procedure. For example, the closed-loop control system may, first, be excited by the on-board signal generator, then a carefully selected set of closed-loop data may be downloaded via telemetry. The in-flight spacecraft control system stability margins then may be identified via the algorithms presented here. Finally, a sharpened attitude controller may be re-designed, if shown to be necessary, and uploaded to the on-board computer.

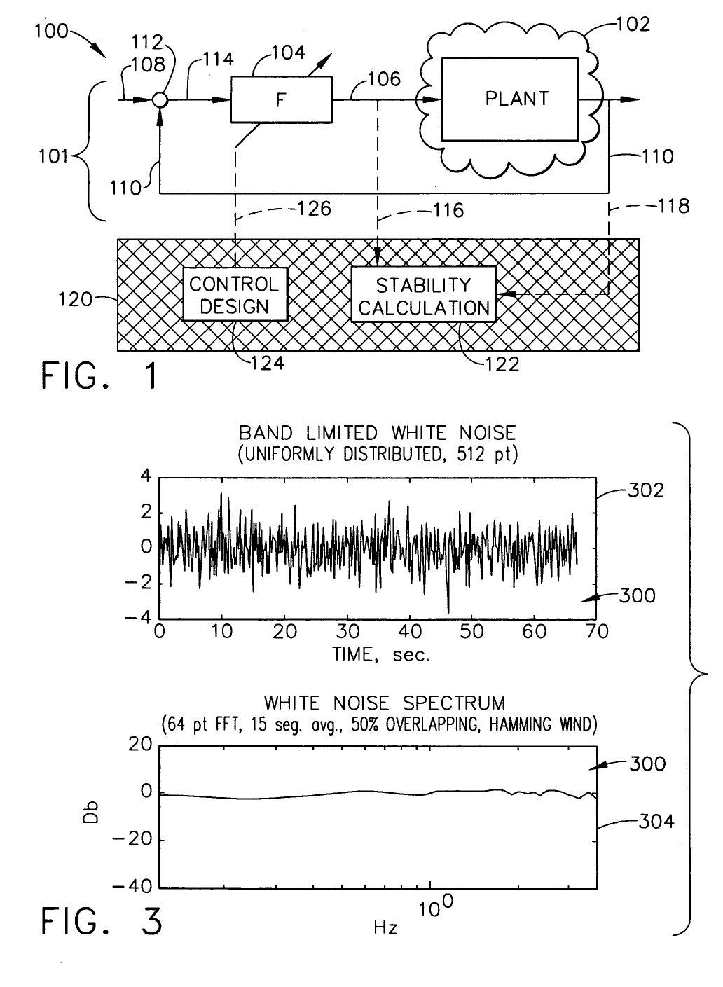

Referring now to the figures, FIG. 1 illustrates an exemplary system 100 for in-flight stability margin assessment (IFSMA) according to an embodiment of the present invention. IFSMA system 100 may include any type of entity or physical plant 102 for which an attitude control system is to be designed and provided. Physical plant 102 may include, for example, the physical plant for an aerospace vehicle or spacecraft, such as a satellite. The entire vehicle or body—including, for example, its physical plant, attitude control system, and processors—may be referred to as control system 101. For purposes of brevity and illustration of one embodiment, system 101 may also be referred to as “spacecraft 101”, however, the description is applicable to any type of vehicle or body considered as a system having a physical plant 102 for which it is appropriate to implement an attitude control system.

Systems 100 and 101 may include a controller 104, which may implement the attitude control system used to control physical plant 102, for example, via control signals 106. Controller 104 may, for example, embody a control law specifically designed for the particular physical plant 102—such as for a spacecraft 101. The control law and operation of the controller 104 may be characterized by a transfer function F, as indicated in FIG. 1 by the label “F” on controller 104. Systems 100 and 101 may receive a reference signal 108. Reference signal 108 may be provided, for example, from an on-board computer or via telemetry from a ground control station. By way of example for illustration purposes, reference signal 108 may be a command to turn spacecraft 101 by ten degrees about some axis. Physical plant 102 may provide a feedback signal 110 for comparison to reference signal 108 and input to controller 104. Feedback signal 110 may be generated by a sensing device and transducer including, for example, a gyro, star tracker, resolver, or position sensor (not shown). Systems 100 and 101 may include a comparator 112 for comparing feedback signal 110 to reference signal 108 and providing a comparison signal 114 to controller 104. Continuing the same illustrative example, controller 104 may continue feeding control signals 106 to physical plant 102 until the feedback signal 110 from a position sensor (for example) indicates that a rotation of spacecraft 101 of ten degrees has been achieved so that feedback signal 110 “matches” reference signal 108 producing a null comparison signal 114, which in turn may be used by controller 104 to provide a control signal 106 to stop further position adjustment of spacecraft 101.

System 100 may include means to provide the input and output signals from physical plant 102 as data to an analysis subsystem 120. For example, physical plant signal input data 116 may be sampled from control signals 106 and provided via telemetry to analysis subsystem 120. Also, for example, physical plant signal output data 118 may be sampled from feedback signals 110 and downloaded via telemetry to analysis subsystem 120. Stability calculation 122 may be performed and attitude control system analysis 124 may be used to update or re-design the control law. For example, updated control parameters 126 may be uploaded via telemetry to controller 104 in order to effect changes to transfer function F that will modify operation of controller 104 and adjust the stability margins of the system (spacecraft) 101.

Still referring to FIG. 1, IFSMA in accordance with one embodiment may proceed as follows. First, the spacecraft 101 may be excited by an on-board signal generator for a few minutes with spacecraft inertially held still without any maneuver interruption, for example, reference signal 108 is maintained as a null signal. The signal generator, for example, may be incorporated into controller 104 and the excitation signals generated may result in a small perturbation of control signals 106 with a resultant output of feedback signals 110 from physical plant 102. The magnitude of the perturbations may be kept small to avoid any potential loss of control involving physical plant 102. Because a null reference signal 108 is maintained, the spacecraft 101 has a tendency to return to its initial attitude once the transients caused by the perturbations die out. The in-flight data provided by control signals 106 and feedback signals 110 may be stored, for example, by an on-board computer, as input data 116 and output data 118.

At the next communication window in the orbit of spacecraft 101, the input/output data 116, 118 may be transmitted via telemetry down to the ground, for example, to analysis subsystem 120. The stability margin may be calculated (stability calculation 122) based on the in-flight spectrum estimates of the stability function or sensitivity function, using the input/output data 116, 118. If the stability margin is similar to what was predicted, no more control system re-design is needed. Otherwise, IFSMA may include re-designing the controller law and uploading to the spacecraft—for example, by uploading control parameters 126 to controller 104 on spacecraft 101—for use in service with proper stability margins.

The IFSMA procedure may be divided into the following steps, which are described in more detail below:
(1) Excite the spacecraft with stability signal generated on-board.
(2) Store the input/output data in an on-board computer.
(3) Telemeter down the I/O data and compute its spectrum estimate.
(4) Plug in pre-determined stability margin formulae and compute for IFSMA.
(5) Re-design control law if necessary.
(6) Telemeter up the new control law, if re-designed, to the controller.

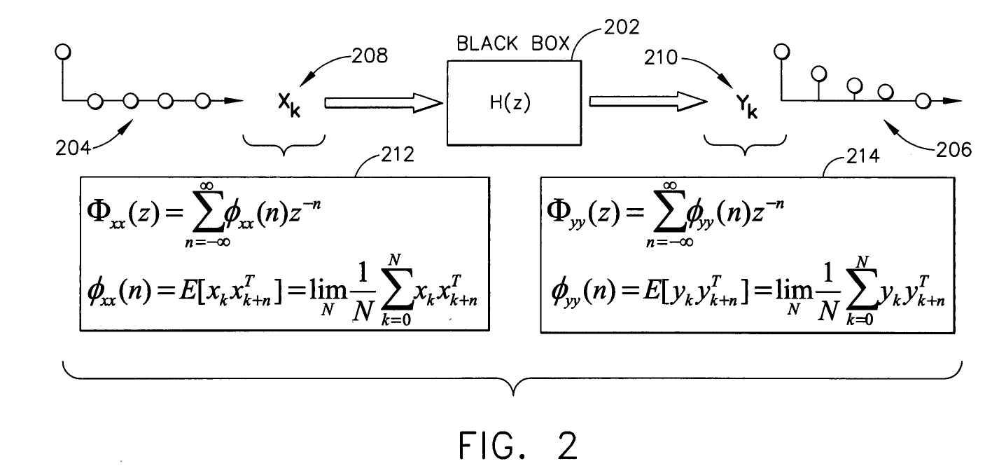

Referring now to FIG. 2, an outline is diagrammed for the mathematical computation of the stability sensitivity function for a controller and physical plant such as spacecraft 101. Spacecraft 101 may be considered to be a black box 202 characterized by a transfer function H(z) as represented in FIG. 2. For example, H(z) may be the composition of transfer functions of the controller 104 and physical plant 102 so that if transfer function F characterizes the controller 104 and transfer function G characterizes the physical plant 102, then H may be represented by H=GF. In general, H may be estimated or computed by comparing inputs 204 to black box 202 with outputs 206 from black box 202. For example, inputs 204 may have the form of a time sequence 208 denoted by xₖ in FIG. 2 and outputs 206 may have the form of a time sequence 210 denoted by yₖ in FIG. 2. Inputs 204 and corresponding outputs 206 may be generated as in steps (1) through (3) above, for example, by exciting the spacecraft 102 with stability signal generated by an on-board signal generator to provide control signals 106 and feedback signals 110 and recording and transmitting the data as input/output data 116, 118, as described above.

Box 212 of FIG. 2 shows the autocorrelation function φ of input sequence 208 and the discrete Fourier transform Φ of the autocorrelation function φ for inputs 204. Likewise, box 214 of FIG. 2 shows the autocorrelation function φ of output sequence 210 and the discrete Fourier transform Φ of the autocorrelation function φ for outputs 206. The stability function estimate for H may be computed mathematically by taking the discrete Fourier transform of the input and output autocorrelation functions to create the so-called “power spectrum” of the input and output data—such as input/output data 116, 118 which may have the form of time sequences 208, 210—in the frequency domain. Then by taking the ratio of the output power spectrum to the input power spectrum, a transfer function magnitude Bode plot of the stability function can be calculated and plotted, such as stability sensitivity function 720 shown in FIG. 7.

Referring now to FIG. 3, a time domain graph 302 and frequency domain graph 304 of a band limited white noise excitation signal 300 are shown in accordance with one embodiment of the present invention. The signal 300 may be supplied by an on-board signal generator as in step (1) above. For example, signal 300 may be fed as control signals 106 to physical plant 102 as shown in FIG. 1. To get a good frequency domain approximation of the in-flight stability function—such as stability sensitivity function 720 shown in FIG. 7—it is preferred to use a wide band spectrum excitation signal to move the spacecraft. Thus, a Uniformly Distributed white noise may be used for the on-board excitation signal 300 as shown in FIG. 3. The white noise, whether it is Uniformly Distributed or Gaussian Distributed, generally has a “flat” spectrum as shown by graph 304 in FIG. 3. As the time domain signal (graph 302) lasts longer, the spectrum (graph 304) turns flatter. This special characteristic ensures that the system 101 can be excited in every frequency range of interest with an equal amount of energy such that the resulting output spectrum—such as a frequency domain graph of output 206—can be evaluated at all relevant frequencies without missing any significant response of the system 101.

Then, the excitation signal at plant input, for example, input data 116, and the response at plant output, for example, output data 118, may be post-processed by the following refinement procedure, which may use Fast Fourier Transform (FFT) techniques:
1. Divide the time domain signal data into equal size (FFT N-point) and overlapped pieces called segments.
2. Apply windowing techniques—such as rectangular, tapered rectangular, triangular, Hanning, Hamming, and Blackman—to each segment of the data.
3. FFT the time domain segments into periodograms.
4. Average the periodograms to get final power spectrum estimates.

In any practical application of IFSMA, the noise embedded in the physical system—such as system 101—can be the major obstacle of getting an accurate plant model—such as an mathematical model of physical plant 102. The IFSMA procedure, according to one embodiment, may window and average out the noise effect, hence producing much more accurate plant models in the frequency ranges of interest.

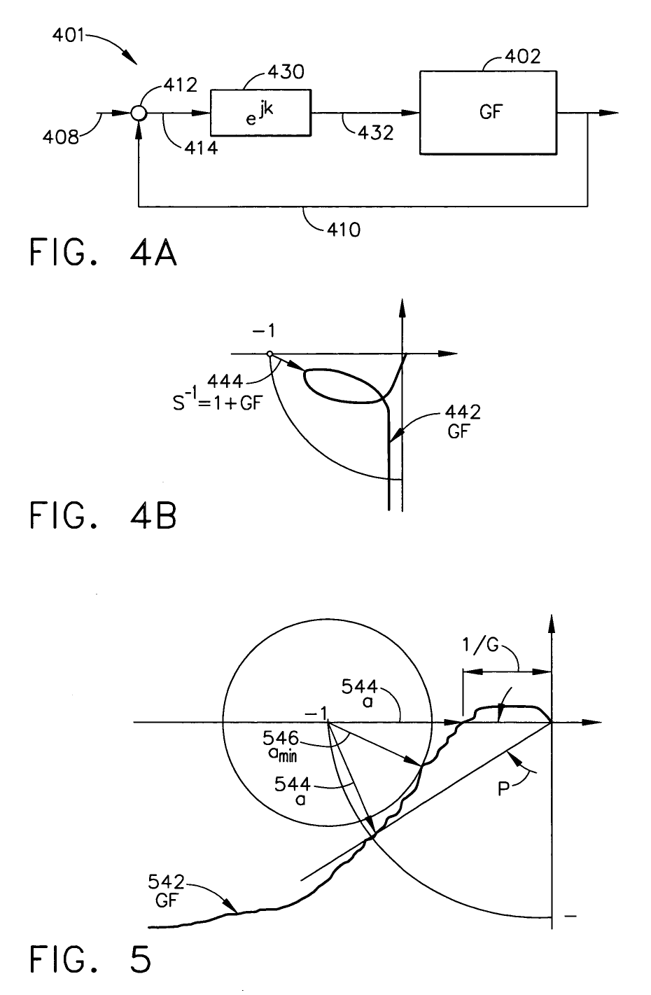

Referring now to FIGS. 4A, 4B, and 5, an illustration is given of the principles underlying assessment of stability margins using the stability sensitivity function determined from the collection of in-flight data according to an embodiment of the present invention. System 401 shown in FIG. 4A corresponds to system 101 shown in FIG. 1 and may be used to mathematically represent system 101 and to show how stability margins may be defined. A gain stability margin and a phase stability margin may both be defined with the aid of FIG. 4A. System 401 may include a transfer function 402 representing the combined operation of controller 104 and physical plant 102 and characterized by transfer function GF, where, as described above, GF may be the composition of transfer function F of the controller 104 and transfer function G of the physical plant 102 so that system 101 may be characterized (in system 401) by the transfer function GF, transfer function 402.

Thus, for example, “F” may represent the control law of the control system and “G” may represent the spacecraft dynamics for spacecraft 101. System 401 may further include a comparator 412 representing system 101 comparator 112, reference signal 408 representing reference signal 108, feedback signal 410 representing feedback signal 110, and comparison signal 414 representing comparison signal 114. System 401 may include stability margin tester 430 characterized by the complex function exp(jK). Stability margin tester 430 exists only in simulation and does not represent an actual part of system 101. The value of K, which is a complex number, may be varied to affect the behavior of system 401. For example, when K=0, exp(jK)=1, so comparison signal 414 is multiplied by 1 in stability margin tester 430 so that test signal 432 is the same as comparison signal 414 and there is no effect on the behavior of system 401. When, for example, the value of K is varied from zero only in its imaginary part, exp(jK) becomes a purely real number so that the test signal 432 is a real multiple of comparison signal 414, i.e., only the gain is affected. When, for example, the value of K is varied from zero only in its real part, exp(jK) becomes a value on the unit circle in the complex plane so that the test signal 432 has the same magnitude as comparison signal 414 but the angle is changed according to the angle of exp(jK) on the unit circle, i.e., only the phase is affected.

Thus, when K varies on the imaginary axis until system 401 goes unstable, the stability “gain margin” (GM) may be defined. Similarly, when K varies on the real axis until system 401 goes unstable, the “phase margin” (PM) of the system may be defined. Stability margins may be defined mathematically in this manner, however, in real life, no one can afford driving the system—such as the actual spacecraft 101—to the vicinity of the instability region and claim the measurement of stability margins. It is not done, for example, because one could simply lose an entire billion dollar spacecraft to an out-of-control situation from which no recovery is possible. Thus, in-flight stability margin assessment, as in one embodiment of the present invention, has not been accomplished in the prior art.

FIG. 4B provides a novel approach to the problem of in-flight stability margin assessment via the so called “system sensitivity function” S=1/(1+GF). If one can compute the closed-loop system sensitivity function S with nominal control laws and plant dynamics, the peak of the stability function—such as peak 725 of stability sensitivity function 710 in FIG. 7—determines the gain margin and phase margin equivalently and more accurately. In FIG. 4B, the transfer function GF of the system, for example, transfer function 402 of system 401, is represented by a curve 442 in the Nyquist plane of complex numbers. At each point X of the curve 442, a vector 444, an example of which is shown in FIG. 4B, may be calculated as X−(−1)=X+1. Thus, the vectors 444 for the transfer function GF of curve 442 may be represented as 1+GF. By the definition of the system sensitivity function S, 1+GF=1/S=S⁻¹, as indicated in FIG. 4B. It may be noted that for values of GF close to −1, the system sensitivity function “blows up”, indicating instability of the system.

FIG. 5 continues the illustration of FIG. 4B using a different example curve 542 for the purpose of providing a clearer illustration. Curve 542, like curve 442, should, however, represent the transfer function GF of the system, for example, transfer function 402 of system 401. Each vector 544, like vectors 444, represents a value of S⁻¹⁼1+GF, and is (generically) denoted by “a”. The vector “a”, or vector 544, of minimum length, vector 546 denoted “aₘᵢₙ”, corresponds to the peak of the system sensitivity function. For a system sensitivity function corresponding to stability sensitivity function 720 shown in FIG. 7, for example, the minimum length vector 546, aₘᵢₙ, may correspond to peak 725 of sensitivity function 720 when curve 542 corresponds to the transfer function GF of the same sensitivity function 720 and the system sensitivity function S=1/(1+GF).

The equations below show the stability margin formulae as determined by the peak of the system sensitivity function, using aₘᵢₙ described above.

$$\begin{matrix}\frac{1}{1 - {a}_{min}} < GM < \frac{1}{1 + {a}_{min}} \\ PM > \pm {sin}^{- 1} ( \frac{{a}_{min}}{2} )\end{matrix}$$

where “aₘᵢₙ” is the reciprocal of the peak of the system sensitivity function. Therefore, by completing the steps 1 through 4 above—for example, post-processing the data 116, 118—with the above formulae, one may achieve IFSMA with a high degree of accuracy.

IFSMA can show how much stability margin actually exists during operation in the mission, for example, of a spacecraft. If the gain or phase stability margin is inadequate, for example, smaller than what is expected to be safe, a redesign of the control law may be necessary and may be undertaken. In doing so, the new control law with an increased stability margin may be uploaded to an on-board computer of the spacecraft—such as spacecraft 101—and used by the controller—such as controller 104—for the rest of the mission operation. With the updated controller, the overall system should be much more robust and the performance should be superior with accurate IFSMA.

### EXAMPLE

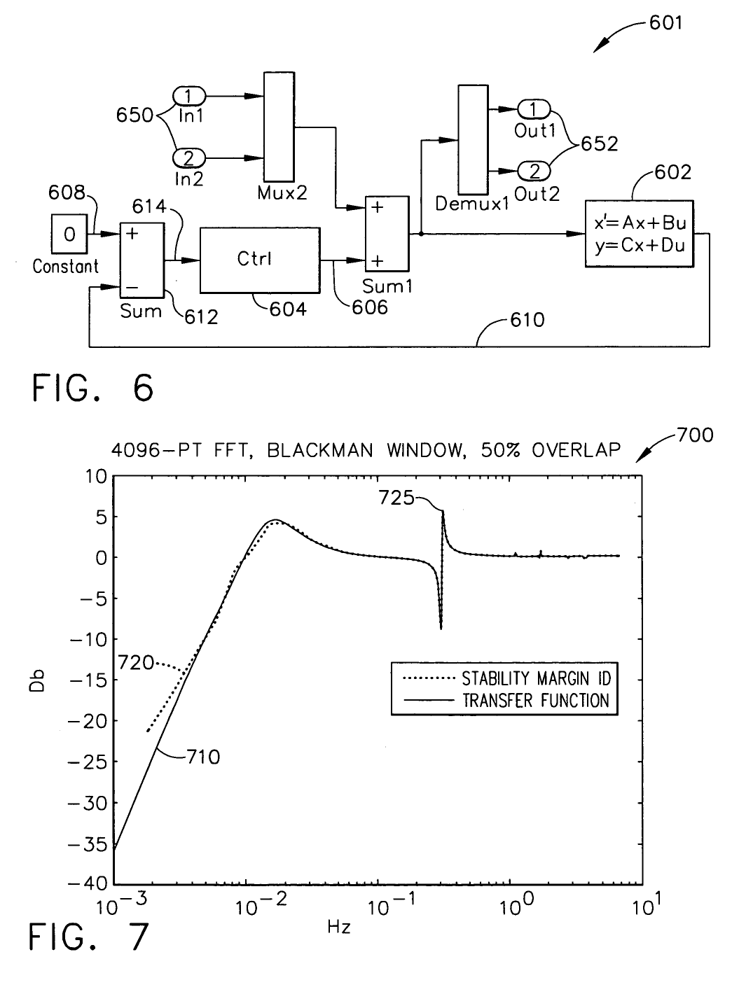

Referring now to FIGS. 6 and 7, IFSMA may be illustrated using an example of an analytical physical plant model. The approach of the illustrative example is to identify the sensitivity function S using the white noise excitation signals, compute the spectrum estimate of S and compare the spectrum estimate of S 720 to the system sensitivity function S 710 of the analytical model in the frequency domain.

A SIMULINK™ block diagram for system model 601, shown in FIG. 6, models a system with nominal control laws and plant dynamics. Thus, an analytical model can be used to provide the “exact” system sensitivity function S 710 shown in FIG. 7 of the analytical model of system model 601. The modeled system may be similar to an actual system such as system 101 shown in FIG. 1. Thus, system model 601 includes a controller 604, model of physical plant 602, reference signal 608, feedback signal 610, comparator 612, comparison signal 614, and control signals 606 modeling corresponding parts of system 101. Block diagram of system model 601 of FIG. 6 illustrates that we excite the model system 601 from inputs 1 and 2, i.e. inputs 650, using white noise signals, and collect the output data at outputs 1 and 2, i.e. outputs 652. This process, for example, models the process of collecting input/output data 116, 118 after exciting system 101 with white noise—such as white noise excitation signal 300. Using the power spectrum estimate tools—such as those available in MATLAB™ and SIMULINK™ and described above, for example, at steps 1 through 4—we can compute the spectrum estimate of the sensitivity function 720 shown in FIG. 7. FIG. 7 shows that the spectrum estimate may have very good agreement with the nominal system sensitivity function of the analytical model.

It should be understood, of course, that the foregoing relates to preferred embodiments of the invention and that modifications may be made without departing from the spirit and scope of the invention as set forth in the following claims.

1. A method for stability margin assessment, comprising a step of:
determining a stability margin from in-flight data.

2. The method of claim 1, further comprising a step of:
determining a stability gain margin from said in-flight data.

3. The method of claim 1, further comprising a step of:
determining a stability phase margin from said in-flight data.

4. The method of claim 1, further comprising a step of:
exciting a control system to produce said in-flight data.

5. The method of claim 1, further comprising a step of:
collecting said in-flight data during operation of a mission.
downloading said in-flight data to an analysis subsystem during operation of said mission.

6. The method of claim 1, further comprising a step of:
computing a spectrum estimate of a system sensitivity function from said in-flight data; and
computing said stability margin using said system sensitivity function.

7. The method of claim 1, further comprising steps of:
computing a spectrum estimate of a system sensitivity function from said in-flight data; and
computing a stability gain margin using said system sensitivity function.

8. The method of claim 1, further comprising steps of:
computing a spectrum estimate of a system sensitivity function from said in-flight data; and
computing a stability phase margin using said system sensitivity function.

9. The method of claim 1, further comprising steps of:
re-designing a control law when a stability gain margin is inadequate; and
uploading a new control law to a controller.

10. The method of claim 1, further comprising steps of:
re-designing a control law when a stability phase margin is inadequate; and
uploading a new control law to a controller.

11. A method for in-flight stability margin assessment, comprising steps of:
determining a stability gain margin from in-flight data; and
determining a stability phase margin from said in-flight data.

12. The method of claim 11, further comprising steps of:
exciting a control system with an excitation signal during operation of a mission to produce said in-flight data;
collecting said in-flight data during operation of said mission; and
downloading said in-flight data via telemetry to an analysis subsystem during operation of said mission.

13. The method of claim 11, further comprising a step of:
computing a spectrum estimate of a system sensitivity function from said in-flight data during operation of a mission;
computing said stability gain margin using said system sensitivity function; and
computing said stability phase margin using said system sensitivity function.

14. The method of claim 11, further comprising steps of:
re-designing a control law when either of said stability gain margin or said stability phase margin is inadequate; and
uploading a new control law via telemetry to a controller during operation of a mission.

15. A method for attitude control system stability margin assessment, comprising steps of:
exciting a control system with a wide band spectrum excitation signal to produce input and output data;
using said input and output data to estimate a system sensitivity function of said control system; and
determining a stability margin of said control system from said system sensitivity function.

16. The method of claim 15, further comprising steps of:
storing said input and output data in an on-board computer during operation of a spacecraft mission; and
downloading said input and output data via telemetry during operation of said spacecraft mission.

17. The method of claim 15, further comprising steps of:
re-designing a control law to provide a new control law with a greater stability when said stability margin is too small; and
uploading said new control law via telemetry to a controller during operation of a spacecraft mission.

18. The method of claim 15, wherein said wide band excitation signal is a white noise signal.

19. The method of claim 15 wherein said wide band excitation signal is a Uniformly Distributed white noise signal.

20. The method of claim 15 wherein said wide band excitation signal is a Gaussian Distributed white noise signal.

21. The method of claim 15 wherein said step of using said input and output data to estimate a system sensitivity function comprises:
taking the discrete Fourier transform of the input autocorrelation function to create an input power spectrum of the input data;
taking the discrete Fourier transform of the output autocorrelation function to create an output power spectrum of the output data;
forming an estimate of said system sensitivity function by taking the ratio of the output power spectrum to the input power spectrum.

22. The method of claim 15 wherein said step of using said input and output data to estimate a system sensitivity function comprises:
dividing said input and output data into equal size (FFT N-point) and overlapped time domain segments;
applying a windowing technique to each of said time domain segments of said input and output data;
applying fast Fourier transform to FFT said time domain segments into periodograms; and
averaging the periodograms to get a final input power spectrum estimate and a final output power spectrum estimate.

23. The method of claim 15 wherein said step of determining a stability margin of said control system from said system sensitivity function comprises determining a gain margin GM from the formula:
$$\frac{1}{1 - {a}_{min}} < GM < \frac{1}{1 + {a}_{min}}$$
where “aₘᵢₙ” is the reciprocal of the peak of said system sensitivity function.

24. The method of claim 15 wherein said step of determining a stability margin of said control system from said system sensitivity function comprises determining a phase margin PM from the formula:
$$PM > \pm {sin}^{- 1} ( \frac{{a}_{min}}{2} )$$
where “aₘᵢₙ” is the reciprocal of the peak of said system sensitivity function.

25. A method for spacecraft attitude control system design, comprising steps of:
exciting a control system with a white noise excitation signal to produce input and output data;
storing said input and output data in an on-board computer during operation of a spacecraft mission;
downloading said input and output data via telemetry during operation of said spacecraft mission.
taking the discrete Fourier transform of the input autocorrelation function of said input data to create an input power spectrum of the input data;
taking the discrete Fourier transform of the output autocorrelation function of said output data to create an output power spectrum of the output data;
estimating a system sensitivity function by taking the ratio of the output power spectrum to the input power spectrum;
determining a first stability margin of the attitude control system from said system sensitivity function by determining a gain margin GM from the formula:
$$\frac{1}{1 - {a}_{min}} < GM < \frac{1}{1 + {a}_{min}}$$
where “aₘᵢₙ” is the reciprocal of the peak of said system sensitivity function; and
determining a second stability margin of the attitude control system from said system sensitivity function by determining a phase margin PM from the formula:
$$PM > \pm {sin}^{- 1} ( \frac{{a}_{min}}{2} )$$
where “aₘᵢₙ” is the reciprocal of the peak of said system sensitivity function.

26. A system for in-flight stability margin assessment, comprising:
a physical plant;
a controller that feeds control signals to said physical plant and receives feedback signals from said physical plant;
a signal generator that excites said physical plant with white noise to provide input and output data;
an analysis subsystem wherein:
said analysis subsystem uses said input and output data to estimate a system sensitivity function of an attitude control system that includes said physical plant and said controller; and
said analysis subsystem determines a stability margin of said attitude control system from said system sensitivity function.

27. The system of claim 26, further comprising:
a comparator, wherein said comparator receives a reference signal, said comparator receives said feedback signal from said physical plant, and said comparator provides a comparison signal to said controller, and wherein:
said attitude control system includes said physical plant, said controller, and said comparator.

28. The system of claim 26 wherein said input and output data is provided to said analysis subsystem via telemetry.

29. The system of claim 26 wherein said analysis subsystem provides a new control law to said attitude control system via telemetry.

30. The system of claim 26 wherein said analysis subsystem calculates a stability margin by determining a gain margin GM from the formula:
$$\frac{1}{1 - {a}_{min}} < GM < \frac{1}{1 + {a}_{min}}$$
where “aₘᵢₙ” is the reciprocal of the peak of said system sensitivity function.

31. The system of claim 26 wherein said analysis subsystem calculates a stability margin by determining a phase margin PM from the formula:
$$PM > \pm {sin}^{- 1} ( \frac{{a}_{min}}{2} )$$
where “aₘᵢₙ” is the reciprocal of the peak of said system sensitivity function.

32. A spacecraft, comprising:
an attitude control system including:
a physical plant;
a controller that feeds control signals to said physical plant;
a comparator, wherein said comparator receives a reference signal, said comparator receives a feedback signal from said physical plant, and said comparator provides a comparison signal to said controller,
a signal generator that excites said physical plant with white noise to provide input and output data from said attitude control system;
wherein said attitude control system is connected via telemetry to an analysis subsystem wherein:
said analysis subsystem uses said input and output data to estimate a system sensitivity function of an attitude control system that includes said physical plant and said controller; and
said analysis subsystem determines a stability margin of said attitude control system from said system sensitivity function.

33. The spacecraft of claim 32 wherein said analysis subsystem calculates a stability margin by determining a gain margin GM from the formula:
$$\frac{1}{1 - {a}_{min}} < GM < \frac{1}{1 + {a}_{min}}$$
where “aₘᵢₙ” is the reciprocal of the peak of said system sensitivity function.

34. The spacecraft of claim 32 wherein said analysis subsystem calculates a stability margin by determining a phase margin PM from the formula:
$$PM > \pm {sin}^{- 1} ( \frac{{a}_{min}}{2} )$$
where “aₘᵢₙ” is the reciprocal of the peak of said system sensitivity function.

35. The spacecraft of claim 32 wherein said analysis subsystem provides a new control law to said attitude control system via telemetry.
